(19) United States
(12) Patent Application Publication
(10) Pub. No.: US 2025/0262545 A1
(43) Pub. Date: Aug. 21, 2025

(54) ADAPTING GAMING SCENARIOS OF A GAME ENGINE

(71) Applicant: Playtika LTD, Herzeliya (IL)

(72) Inventors: Illia BIEZHENUSOV, Warszawa (PL); Oksana MOTRUK, Kharkiv (UA); Yuval MEY-TAL, Tel Aviv (IL)

(73) Assignee: Playtika LTD, Herzeliya (IL)

(21) Appl. No.: 19/058,076

(22) Filed: Feb. 20, 2025

Related U.S. Application Data
(60) Provisional application No. 63/555,941, filed on Feb. 21, 2024.

(51) Int. Cl. A63F 13/69; A63F 13/53; A63F 13/798

(52) U.S. Cl. CPC A63F 13/69; A63F 13/53; A63F 13/798; A63F 2300/638

(57) ABSTRACT

There is provided a method, comprising: accessing a candidate gaming scenario associated with a desired outcome(s) of users interacting with a gaming engine implementing the candidate gaming scenario, identifying, in the gaming engine, a sub-set of the users interacting with the gaming engine for analyzing the candidate gaming scenario implemented by the gaming engine, virtually implementing the candidate gaming scenario by the gaming engine for interaction by the users as if the candidate gaming scenario is not virtually implemented, collecting data on the sub-set of users, computing a game related result(s) predicted to occur when the new gaming scenario is explicitly implemented by the candidate gaming engine using the data collected for the virtually implemented candidate gaming engine scenario, and in response to the game related scenario(s) meeting a target, explicitly implementing the candidate gaming scenario for interaction by the users.

### RELATED APPLICATION(S)

This application claims the benefit of priority under 35 USC § 119 (e) of U.S. Provisional Patent Application No. 63/555,941 filed on Feb. 21, 2024, the contents of which are all incorporated by reference as if fully set forth herein in their entirety.

### FIELD AND BACKGROUND OF THE INVENTION

The present invention, in some embodiments thereof, relates to game engines and, more specifically, but not exclusively, to systems and methods for selecting a game scenario for implementation by a gaming engine.

Adaptation of a game scenario of a game may be adapted as part of a game balancing process. For example, to help ensure that the gameplay is fair, challenging, and/or enjoyable for users.

### SUMMARY OF THE INVENTION

According to a first aspect, a computer implemented method of predicting an effect of a candidate gaming scenario on users interacting with a gaming engine implementing the candidate gaming scenario, comprising: accessing, in conjunction with a service engine configured to manage the gaming engine, the candidate gaming scenario to be implemented in the gaming engine and in conjunction with the users, wherein the candidate gaming scenario is associated with at least one desired outcome of users interacting with the gaming engine implementing the candidate gaming scenario, identifying, in the gaming engine and in conjunction with the service engine, a sub-set of the users interacting with the gaming engine for analyzing the candidate gaming scenario implemented by the gaming engine, virtually implementing the candidate gaming scenario by the gaming engine for interaction by the users as if the candidate gaming scenario is not virtually implemented, collecting data, by the service engine, on the sub-set of users identified, in conjunction with the users interacting with the gaming engine virtually implementing the candidate gaming scenario, computing at least one game related result predicted to occur when the new gaming scenario is explicitly implemented by the candidate gaming engine using the data collected for the virtually implemented candidate gaming engine scenario, and in response to the at least one game related scenario meeting a target, explicitly implementing the candidate gaming scenario for interaction by the users.

According to a second aspect, a system for predicting an effect of a candidate gaming scenario on users interacting with a gaming engine implementing the candidate gaming scenario, comprising: at least one processor executing a code for: accessing, in conjunction with a service engine configured to manage the gaming engine, the candidate gaming scenario to be implemented in the gaming engine and in conjunction with the users, wherein the candidate gaming scenario is associated with at least one desired outcome of users interacting with the gaming engine implementing the candidate gaming scenario, identifying, in the gaming engine and in conjunction with the service engine, a sub-set of the users interacting with the gaming engine for analyzing the candidate gaming scenario implemented by the gaming engine, virtually implementing the candidate gaming scenario by the gaming engine for interaction by the users as if the candidate gaming scenario is not virtually implemented, collecting data, by the service engine, on the sub-set of users identified, in conjunction with the users interacting with the gaming engine virtually implementing the candidate gaming scenario, computing at least one game related result predicted to occur when the new gaming scenario is explicitly implemented by the candidate gaming engine using the data collected for the virtually implemented candidate gaming engine scenario, and in response to the at least one game related scenario meeting a target, explicitly implementing the candidate gaming scenario for interaction by the users.

According to a third aspect, a non-transitory medium storing program instructions for predicting an effect of a candidate gaming scenario on users interacting with a gaming engine implementing the candidate gaming scenario, which when executed by at least one processor, cause the at least one processor to: access, in conjunction with a service engine configured to manage the gaming engine, the candidate gaming scenario to be implemented in the gaming engine and in conjunction with the users, wherein the candidate gaming scenario is associated with at least one desired outcome of users interacting with the gaming engine implementing the candidate gaming scenario, identify, in the gaming engine and in conjunction with the service engine, a sub-set of the users interacting with the gaming engine for analyzing the candidate gaming scenario implemented by the gaming engine, virtually implement the candidate gaming scenario by the gaming engine for interaction by the users as if the candidate gaming scenario is not virtually implemented, collect data, by the service engine, on the sub-set of users identified, in conjunction with the users interacting with the gaming engine virtually implementing the candidate gaming scenario, compute at least one game related result predicted to occur when the new gaming scenario is explicitly implemented by the candidate gaming engine using the data collected for the virtually implemented candidate gaming engine scenario, and in response to the at least one game related scenario meeting a target, explicitly implement the candidate gaming scenario for interaction by the users.

In a further implementation form of the first, second, and third aspects, the candidate gaming scenario comprises a candidate reward scenario defining a replacement of an existing reward calculation with an adapted reward calculation for virtual allocation of rewards, wherein the rewards are virtually allocated for each user without presenting an indication of the virtually allocated rewards.

In a further implementation form of the first, second, and third aspects, the service engine calculates the rewards that each user would have earned based on their interactions and performance under the candidate reward scenario, by application of predefined rules and criteria of the virtual reward scenario to ascertain the virtual rewards each user would have received, providing a simulated representation of potential reward outcomes without actual explicit distribution of rewards to the users.

In a further implementation form of the first, second, and third aspects, types of rewards within the candidate gaming scenario for virtual allocation comprise at least one of: (i) in-game currency, (ii) virtual items, (iii) character enhancements, (iv) experience points, (v) exclusive access to game content, and (vi) achievements.

In a further implementation form of the first, second, and third aspects, the adapted reward calculation comprises applying predefined rules and criteria of the candidate reward scenario to determine the virtual rewards each user would have earned without explicitly allocating the rewards to each user.

In a further implementation form of the first, second, and third aspects, further comprising presenting the calculated potential reward outcomes on a display in a comprehensible format indicating the calculated potential rewards outcomes based on the adapted reward calculation that are virtually determined and non-presented to users and reward outcomes based on the existing reward calculation that are presented to users.

In a further implementation form of the first, second, and third aspects, further comprising presenting a user interface (GUI) on the display configured for reviewing and/or analyzing the calculated potential reward outcomes based on the adapted reward calculation and the reward outcomes based on the existing reward calculations, and configured for enabling the user to activate the candidate reward scenario.

In a further implementation form of the first, second, and third aspects, the candidate reward scenario is automatically implemented in response to a comparison between the reward outcomes computed according to the adapted reward calculation and predetermined expectations and/or performance benchmarks computed according to the existing reward calculation.

In a further implementation form of the first, second, and third aspects, the candidate gaming scenario comprises a virtual time challenge scenario, wherein users are tasked with completing specific virtual in-game objectives and/or achieving virtual milestones within virtual predefined time limits without being presented with the virtual in-game objectives, indication of whether the virtual milestones are met, and virtual predefined time limits, in which the service engine collects data on user interactions during the virtual time challenge scenario, calculates virtual outcomes based on user performance against virtual time-related criteria, and presents the calculated results on a display that is different than displays of client terminals of the users without presenting an indication of the virtual time challenge scenario on the client terminals of the users.

In a further implementation form of the first, second, and third aspects, the candidate gaming scenario comprises a hidden objectives scenario that is non-presented on client terminals of users such that users engage with the game engine without explicit knowledge of undisclosed in-game objectives, in which the service engine collects data on user interactions during the hidden objectives scenario without presenting an indication of the hidden objective scenario on client terminals used by users throughout the data collection phase, and in which the calculation of the at least one game related result comprises determining virtual outcomes based on user actions related to the undisclosed in-game objectives, and the calculated at least one game related result is presented on a display that is different than displays of client terminals of the users without presenting an indication of the hidden objectives scenario on the client terminals of the users.

In a further implementation form of the first, second, and third aspects, further comprising categorizing users within the identified sub-set into user groups based on at least one of: (i) user characteristics, (ii) preferences, (iii) behaviors, and (iv) game-play, and wherein the at least one game related result is predicted for each user group.

In a further implementation form of the first, second, and third aspects, the service engine is configured to analyze the distribution of computed at least one game related result within each identified user group.

In a further implementation form of the first, second, and third aspects, the service engine is configured to identify patterns and/or trends across distinct user groups, for providing insights regarding the actual activation of the candidate gaming scenario.

In a further implementation form of the first, second, and third aspects, virtually implementing the candidate gaming scenario comprises not presenting an indication of the candidate gaming scenario and/or an indication of the virtual implementation on client terminals of the users, and wherein explicitly implementing the candidate gaming scenario comprises presenting the indication of the implemented candidate gaming scenario on the client terminals of the users.

In a further implementation form of the first, second, and third aspects, the identified sub-set of users comprises a first user sub-set, and the candidate gaming scenario is implemented for the first user sub-set and non-implemented for a second user sub-set different from the first sub-set, wherein the first user sub-set and the second user sub-set are simultaneously interacting with the gaming engine, wherein no indication of allocation of a user to the first user sub-set or to the second user sub-set is presented on a display of a client terminal of the user.

In a further implementation form of the first, second, and third aspects, the first user sub-set and the second user sub-set are statistically similar, for enabling a randomized blinded control trial.

In a further implementation form of the first, second, and third aspects, the candidate gaming scenario is automatically explicitly implemented by the gaming engine in response to the target indicating a statistically significant positive outcome in a difference between the first user sub-set and the second user sub-set.

In a further implementation form of the first, second, and third aspects, the candidate gaming scenario is automatically explicitly implemented by the gaming engine in response to the target indicating a statistically non-significant difference between the first user sub-set and the second user sub-set.

In a further implementation form of the first, second, and third aspects, the identified sub-set of users is selected according to a prediction of being significantly impacted by the candidate gaming scenario.

In a further implementation form of the first, second, and third aspects, the target denotes a balance of the gaming engine obtained by implementing the candidate gaming scenario for reducing likelihood of domination by a single strategy, character, item, an ability, for fair and enjoyable play by the user.

In a further implementation form of the first, second, and third aspects, the identified sub-set of users represents a statistical sample of users that historically interacted with the gaming engine, and/or are currently interacting with the gaming engine, and/or are predicted to interact with the gaming engine in the future.

In a further implementation form of the first, second, and third aspects, the sub-set of users is identified by analyzing at least one parameter of each user denoting a selected segment of users, the at least one parameter including at least one of: skill level, play style, and demographics.

In a further implementation form of the first, second, and third aspects, the at least one game related result is computed by adjusting the collected data according to a predicted adjustment factor indicating predicted impact on users being presented with an indication of the implemented candidate gaming scenario in comparison to users being unaware of the implemented candidate gaming scenario.

In a further implementation form of the first, second, and third aspects, the predicted adjustment factor is computed by analyzing a first set of users interacting with a game engine in which a candidate gaming scenario is explicitly implemented and a second set of users interacting with a game engine in which the candidate gaming scenario is virtually implemented.

Unless otherwise defined, all technical and/or scientific terms used herein have the same meaning as commonly understood by one of ordinary skill in the art to which the invention pertains.

Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for predicting an effect of a candidate gaming scenario on users interacting with a gaming engine implementing the candidate gaming scenario, in accordance with some embodiments of the present invention; and

FIG. 2 is a flowchart of a method of predicting an effect of a candidate gaming scenario on users interacting with a gaming engine implementing the candidate gaming scenario, in accordance with some embodiments of the present invention.

### DESCRIPTION OF SPECIFIC EMBODIMENTS OF THE INVENTION

The present invention, in some embodiments thereof, relates to game engines and, more specifically, but not exclusively, to systems and methods for selecting a game scenario for implementation by a gaming engine.

As used herein, the terms gaming engine and game engine are interchangeable.

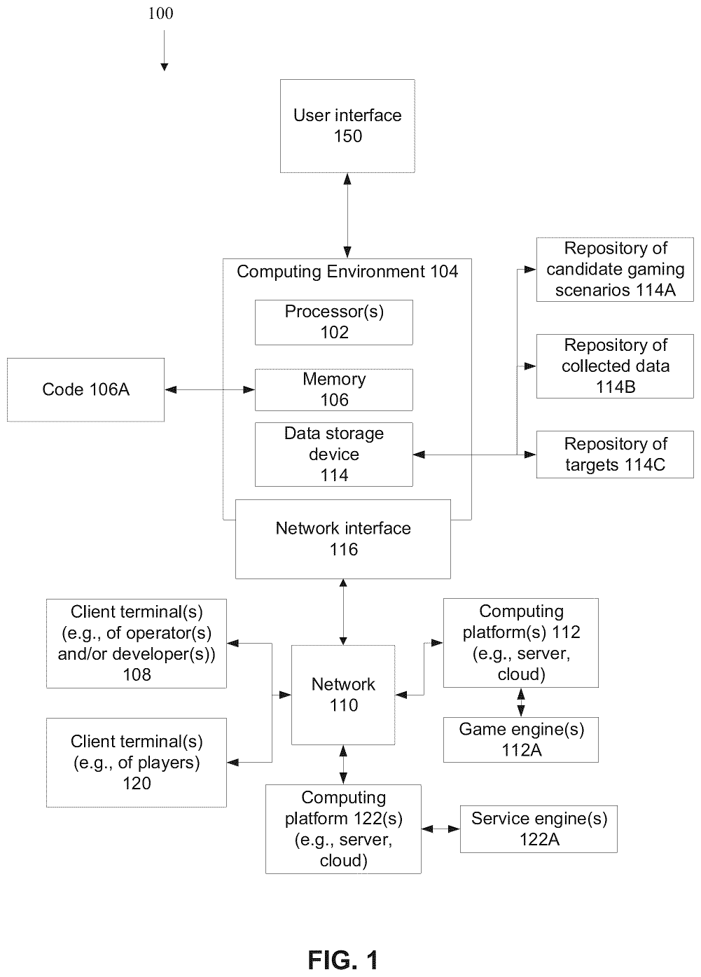

As used herein, embodiments relates to a service engine in communication with the game engine are exemplary and not necessarily limiting. In some embodiments, the service engine may be omitted, and features described herein implemented by the service engine may be performed by other components, for example, by the gaming engine, by the computing environment described herein (e.g., with reference to FIG. 1), and the like.

As used herein, the term players and users, referring to people interacting with the gaming engine by playing the game hosted by the gaming engine, are interchangeable.

An aspect of some embodiments of the present invention relates to systems, methods, devices, and/or code instructions (stored on a data storage device and executable by one or more processors) for predicting an effect of a candidate gaming scenario on users interacting with a gaming engine implementing the candidate gaming scenario. The candidate gaming scenario to be implemented in the gaming engine running a game played by one or more users, is accessed.

Examples of candidate gaming scenarios include: changing a calculation for allocation of virtual rewards, a time challenge scenario, and an in-game objective scenario. A service engine may manage the gaming engine, for example, obtaining data from the service engine, and/or configuring the service engine. The candidate gaming scenario is virtually implemented by the gaming engine (and/or by the service engine) for interaction by the users as if the candidate gaming scenario is not virtually implemented. The users are unaware of the virtual implementation during their interaction with the gaming engine. The virtual implementation does not visibly impact the interaction of the user. No indication of the virtual implementation is presented on the display of the client terminal of a user playing the game. Data on users interacting with the gaming engine virtually implementing the candidate gaming scenario is collected by the service engine. One or more game related results predicted to occur when the new gaming scenario is explicitly implemented by the candidate gaming engine are computed using the data collected for the virtually implemented candidate gaming engine scenario. For example, amount of rewards users have collected using the virtually implemented reward allocation, whether users met or did not meet the time challenge, and the like. The candidate gaming scenario may be explicitly implemented for interaction by the users in response to the game related result meeting a target. Alternatively, the candidate game scenario is not explicitly implemented when the game related result does not meet the target.

At least some implementations described herein address the technical problem of determining which candidate gaming scenario to implement in a gaming engine. At least some implementations described herein improve the technical field of game engines, by providing approaches for determining which candidate gaming scenario to implement in a gaming engine. At least some implementations described herein improve over prior approaches of determining which candidate gaming scenario to implement in a gaming engine, for example, manual trial and error approaches where the gaming scenario is implemented, data is collected while players interact with the game scenario, and the data is analyzed whether to keep the game scenario or not. In another example, the gaming scenario may be selected by a developer with domain knowledge.

Determining which gaming scenario to implement in a game involves various challenges, as developers need to consider different multiple factors such as player engagement, narrative cohesion, technical feasibility, and resource constraints. One of the primary challenges is determining which gaming scenario will resonate most with players and keep them engaged throughout the gameplay experience. Developers need to consider factors such as player preferences and demographic considerations to identify scenarios that will appeal to their target audience. Implementing certain gaming scenarios may present technical challenges related to game engine capabilities and/or hardware limitations. Different gaming scenarios may require unique gameplay mechanics and systems to be implemented effectively. Developers need to assess whether the chosen scenario aligns with the game's core mechanics and whether it can be integrated seamlessly into the existing gameplay framework. For example, allocation of too many rewards too easily may increase in-game inflation to the point that playing is not enjoyable and/or challenging and/or motivating.

At least some embodiments described herein provide a solution for the aforementioned technical problem, and/or improve the aforementioned technical field, and/or improve upon the aforementioned prior approaches, by virtual implementation of the candidate gaming scenario, without the users being aware of the virtual implementation. The virtual implementation enables data collection and/or evaluation of actual real effects that happen by implementation of the candidate gaming scenario, without modification of the game from the perspective of the players playing the game. I.e., the players play the game with virtually implemented candidate gaming scenario for collecting data regarding impact of the implemented candidate gaming scenario without the players themselves being aware of the virtually implemented game. The effect of explicitly implementing the candidate gaming scenario of the gaming engine is predicted based on the analysis of the data. One or more game related results predicted to occur when the new gaming scenario is explicitly implemented by the candidate gaming scenario are computed using the data collected for the virtually implemented candidate gaming scenario. A decision of whether or not to explicitly implement the candidate gamine scenario may be made, for example, based on whether or not the game related result(s) meet a target.

An example of using a virtual implementation of the candidate gaming scenario to predict a game related result is now described. The candidate gaming scenario may indicate virtually giving an amount (e.g., 10) in-game tokens to each player able to complete a certain task in an amount of time (e.g., 15 minutes) from start of play. The virtually allocated amount and/or the virtual time limit is not presented on a display of the players, so that the players are unware of the virtual amount, and/or of the time limit. Data is collected by the service engine for the players interacting with the gaming engine virtually implementing the candidate gaming scenario. The game related result indicates that 20% of users are able to virtually get the 10 tokens. The game related result does not meet the target. The “10 tokens” and “15 minute” parameters cannot sustain the in game-economy. These parameters are too high for the in-game economy since they will likely lead to in-game inflation. A different values for the parameters predicted for sustaining the in-game economy may be explicitly implemented, for example, “7 tokens” and “10 minutes”.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

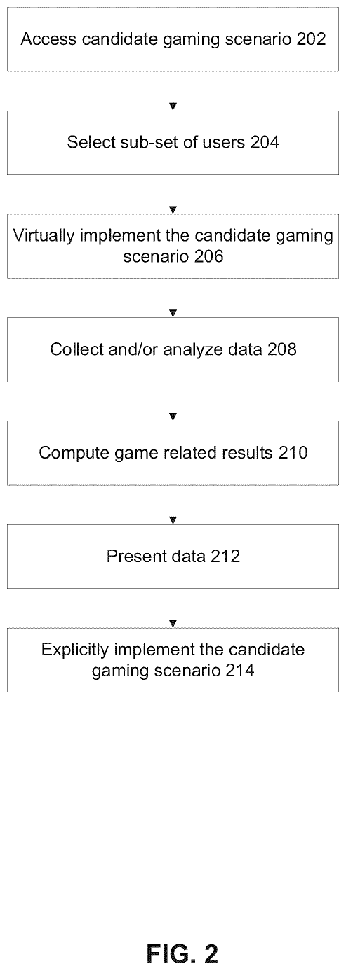

Reference is now made to FIG. 1, which is a block diagram of components of a system 100 for predicting an effect of a candidate gaming scenario on users interacting with a gaming engine implementing the candidate gaming scenario, in accordance with some embodiments of the present invention. Reference is also made to FIG. 2, which is a flowchart of a method of predicting an effect of a candidate gaming scenario on users interacting with a gaming engine implementing the candidate gaming scenario, in accordance with some embodiments of the present invention.

System 100 may implement the acts of the method described with reference to FIG. 2 by processor(s) 102 of a computing environment 104 executing code instructions 106A stored in a memory 106 (also referred to as a program store). Computing environment 104 may be in communication with a service engine 122A that interacts with a gaming engine 112A. Alternatively or additionally, computing environment 104 may be integrated with service engine 122A, for example, code 106A is executed by a processor running service engine 122A.

In another architecture, service engine 122A and gaming engine 112A are integrated into a single component, for example, features described with reference to service engine 122A are run by gaming engine 112A.

Computing environment 104 may be implemented as, for example one or more and/or combination of: a computing cloud, a group of connected devices, a server, a virtual server, a client terminal, a virtual machine, a desktop computer, a thin client, a network node, and/or a mobile device (e.g., a Smartphone, a Tablet computer, a laptop computer, a wearable computer, glasses computer, and a watch computer).

Game engine 112A may be hosted by a computing platform 112, for example, a server and/or computing cloud. Game engine 112A is designed for interactions, optionally simultaneously, by multiple players (also referred to herein as users), optionally using respective client terminals 120 via a network 110.

A service engine 122A may be hosted by a computing platform 122, for example, a server and/or computing cloud. Service engine 122A communicates with game engine 112A, for example, monitoring interaction of players using client terminals 120 for with game engine 112A. Service engine 122A may operate game engine 112A, for example, implement new gaming scenarios, and/or adapting existing gaming scenarios, as described herein.

Computing platform 122 running service engine 122A may be different than computing platform 112 running compiled game engine 112A.

Multiple architectures of system 100 based on computing device 104 may be implemented. For example:
Computing environment 104 may be separate from computing platform 122 and/or from computing platform 112. Alternatively, computing environment 104 is operated by, running on, and/or integrated with computing platform 122.
Computing environment 104 may centrally virtually implement candidate gaming scenarios for different game engines, and may centrally compute game related results for the different game engines based on different users interacting during the virtual implementation of respective candidate gaming scenarios. Game engines 112A may run on different computing platforms 112. Service engines 122A may run on different computing platforms 122. Different candidate gaming scenarios for different game engines may be provided to computing environment 104 by different client terminals 108 such as of different operators of service engines 122A. The outcome of respective game related results predicted to occur computed by analyzing users interacting with respective game engines 112A virtually implementing respective gaming scenarios may be provided back to the corresponding client terminals 108, for example, for presentation on a display for manual review and/or for determining whether to implement respective candidate game scenarios by the operator.
Computing environment 104 may virtually implement candidate gaming scenario(s) of a specific game engine 114A which may be associated with a specific service engine 122A.
Computing environment 104 may virtually implement candidate gaming scenario(s) of one or more game engines 114A associated with a specific service engine 122A.
Computing environment 104 may be locally run by a certain developer and/or operator, or development and/or operating entity, for example, creating a specific game by adding a new gaming scenario to game engine 114A. For example, the developer uses computing environment 104 to generate different candidate game scenarios for game engine 112A. Game engine 112A may be run by computing platform 112 which is different than computing environment 104. Monitoring of users interacting with game engine 112A with virtually implementation of the new gaming scenario may be done by service engine 122A, computing platform 122, computing platform 112, and/or computing environment 104.

Computing environment 104 may provide the service of virtually implementing candidate gaming scenarios, collecting data of users interacting with the game engine virtually implementing the candidate gaming scenarios, and/or computing game related result(s), for example by: providing software as a service (SaaS) to the client terminal(s) 108, providing software services accessible using a software interface (e.g., application programming interface (API), software development kit (SDK)), providing an application for local download to the client terminal(s) 108, providing an add-on to a web browser running on client terminal(s) 108, and/or providing functions using a remote access session to the client terminals 108, such as through a web browser executed by client terminal 108 accessing a web site hosted by environment device 104 such as remote access of computing environment 104.

Processor(s) 102 of computing environment 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIG. 2 when executed by processor(s) 102.

Computing environment 104 may include a data storage device 114 for storing data, for example, repository of candidate gaming scenarios 114A for storing different candidate gaming scenarios, repository of collected data 114B for storing data collected from users interacting with the game engine virtually implementing the candidate gaming scenario, and repository of targets 114C for evaluating game related outcomes obtained by analyzing the data, and/or other data as described herein. Data storage device 114 may be implemented as, for example, a memory, a local hard-drive, virtual storage, a removable storage unit, an optical disk, a storage device, and/or as a remote server and/or computing cloud (e.g., accessed using a network connection). It is noted that code stored on data storage device 114 may be loaded into memory 106 for execution by processor(s) 102.

Network 110 may be implemented as, for example, the internet, a local area network, a virtual network, a wireless network, a cellular network, a local bus, a point to point link (e.g., wired), and/or combinations of the aforementioned.

Computing environment 104 may include a network interface 116 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing device 104 (and/or other components such as client terminals 108, 120) includes and/or is in communication with one or more physical user interfaces 150 that include a mechanism for a user to enter data (e.g., define candidate gaming scenarios) and/or view data (e.g., user interface presenting game related outcomes computed by analyzing data of users interacting with the game engine virtually implementing the candidate game scenario). Exemplary user interfaces 150 include, for example, one or more of, a touchscreen, a display, a virtual reality display (e.g., headset), gesture activation devices, a keyboard, a mouse, and voice activated software using speakers and microphone.

Referring now back to FIG. 2, it is noted that features described as being performed by the service engine are meant to be understood as representing a not necessarily limiting example. Features described as being performed by the service engine may be performed by another processor and/or device, for example, by the gaming engine, and/or another server.

At 202, a candidate gaming scenario to be implemented in a gaming engine running a game, is accessed.

The candidate gaming scenario may be designed to be implemented in a multi-player game, where players are able to interact with one another, in real-time and/or offline. For example, players may compete with one another, may help each other (e.g., fight an enemy), send messages to each other, and/or buy and sell items to one another using in-game tokens they earned. Alternatively or additionally, the candidate gaming scenario may be designed for a single player game, where each players plays the game alone.

The candidate gaming scenario may be implemented in conjunction with a service engine that manages the gaming engine.

Examples of candidate gaming scenarios include:
Replacement of an existing reward calculation with an adapted reward calculation for allocation of rewards. For example, in the original version of the game, players earn rewards primarily based on the number of levels they complete. For each level completed, players receive a fixed amount of in-game currency (coins) and experience points (XP). The rewards remain constant regardless of the player's performance within the level. Issues with the existing reward calculation may be, for example, that players who struggle to complete levels feel discouraged because they receive the same rewards as more skilled players. There's little incentive for players to improve their performance or engage with more challenging levels. The reward system doesn't adequately recognize and reward skillful gameplay. To address the issues with the existing reward calculation and improve player engagement, the game developers are deciding whether to implement an adapted reward calculation based on performance within each level. The adapted reward calculation may consider factors such as completion time, number of stars earned (indicating performance quality), and any bonus objectives achieved. For example players who complete levels faster receive additional bonus coins and XP. This change is predicted to provide an incentive to players to improve their speed and efficiency. Players may be rewarded based on the number of stars earned in each level. For example, earning three stars (indicating a flawless performance) grants a significant bonus, while earning fewer stars results in a proportional decrease in rewards. Completing optional bonus objectives within levels, such as collecting hidden items or achieving a certain score threshold, grants additional rewards.
A time challenge scenario. Users are tasked with completing specific in-game objectives and/or achieving milestones within predefined time limits. The time challenge scenario may be in a racing game where users are tasked with completing specific in-game objectives within predefined time limits. For example, players need to navigate through a series of checkpoints scattered across a challenging race track within a predefined time limit.
In-game objective scenario. For example, for a fantasy adventure game where users are tasked with completing specific objectives to progress through the game.

The candidate gaming scenario may be obtained, for example:
Manually defined, such as by an operator of the service engine and/or gaming engine.
Incremental adaptation of an existing gaming scenario. The incremental adaptation may be performed as part of a trial-and-error approach of attempting to find improved gaming scenarios.
Based upon a prediction, for example, by a machine learning model that analyzes parameters of the gaming engine, and/or by another process. The prediction may be evaluated to determine whether to implement the prediction or not.
Randomly generated.
Based on an analysis of historical values of the existing gaming scenario, and/or previously run gaming scenarios.

At 204, a sub-set of the users interacting with the gaming engine may be selected and/or identified for analyzing the candidate gaming scenario to be implemented by the gaming engine. Alternatively, no sub-set is selected, rather, all players of the game may be evaluated.

The sub-set may be selected, for example, from users that are currently interacting with the gaming engine, and/or regular users (e.g., subscribers) that are not necessarily currently interacting with the gaming engine but are predicted to interact with the gaming engine (e.g., in the near future, for resuming an existing game and/or for playing a new game).

The identified sub-set of users may represent a statistical sample of users that historically interacted with the gaming engine, and/or are currently interacting with the gaming engine, and/or are predicted to interact with the gaming engine in the future. The statistical sample may be obtained, for example, according to a statistical approach that analyzes a distribution of users, such as according to parameters, and selects a sample of the users that are statistically similar to the set of users. Alternatively or additionally, the sub-set of users may be randomly selected.

The sub-set of users may be identified according to a prediction of being significantly impacted by the candidate gaming scenario. For example, manually by an operator with domain knowledge, based on a historical analysis of interactions of users and impact of historical changes to the interactions of the users, and/or based on a prediction machine learning model (e.g., trained on a training dataset of user interactions and gaming scenarios).

The sub-set of users may be identified by analyzing one or more parameters of each user denoting a selected segment of users. Examples of parameters or users include: skill level (e.g., beginner, intermediate, advanced, expert), play style (e.g., aggressive, defensive, stealthy, explorative, and social), geographical location (e.g., people in different cities and/or countries may have different preferences and/or may play differently), and demographics (e.g., age, income, education level, marital status, occupation, health status). The parameters of the selected user-group may correspond to the expected impact of the candidate gaming scenario. For example, users identified as beginners may be rewarded more coins when they complete the same task as advanced users. In another example, users identified as social may be required to interact more with other players and/or with non-player characters (NPC) to achieve in-game objects, whereas users identified as explorative may be required to explore more virtual worlds to achieve in game-objectives. In yet another example, some candidate gaming scenarios may be suitable for adults but unsuitable for children.

Optionally, two (or more) different user sub-set may be identified, referred to herein as a first user sub-set and a second user sub-set. The two user sub-sets may be mutually exclusive, such that a user that is a member of one sub-set cannot be a member of the other sub-set. Users may be unaware of their assignment to the first user sub-set or to the second user sub-set. Optionally, no indication of allocation of a user to the first user sub-set or to the second user sub-set is provided, such as no presentation on a display of a client terminal of the user.

At 206, the candidate gaming scenario may be virtually implemented by the gaming engine. The virtual implementation refers to the users interacting with the gaming engine implementing the candidate gaming scenario while being unaware of the implementation of the candidate gaming scenario. The users interact with the gaming engine virtually implementing the candidate gamine scenario as if the candidate gaming scenario is not virtually implemented. No indication of the virtually implemented candidate gaming scenario is presented on a display of a client terminal of a player. The implementation may be done in the “background” or “behind the scenes”. For example, when the player earns 10 tokens using the preceding gaming scenario and is meant to earn 15 tokens using the candidate gaming scenario, the display of the client terminal of the player shows 10 tokens, while 15 tokens are recorded in the background such as by the service engine.

Examples of virtual implementation for different types of candidate gaming scenarios are now described.

For the implementation of the candidate gaming scenario including a reward scenario defining replacement of the existing reward calculation with the adapted reward calculation for allocation of rewards, the virtual implementation of the adapted reward calculation may be done by applying predefined rules and/or criteria of the candidate reward scenario to determine the virtual rewards each user would have earned without explicitly allocating the rewards to each user. The rewards are virtually allocated for each user without presenting an indication of the virtually allocated rewards.

The service engine may calculate the rewards that each user would have earned based on their interactions and performance under the candidate reward scenario. The rewards may be calculated by application of predefined rules and/or criteria of the virtual reward scenario to ascertain the virtual rewards each user would have received. The virtual computation of the rewards may provide a simulated representation of potential reward outcomes without actual explicit distribution of rewards to the users.

Examples of types of rewards within the candidate gaming scenario for virtual allocation include:
In-game currency, which may be used within the game, for example, to purchase items, upgrades, and/or in-game assets. Examples of in-game currency include: gold, token, and coins.
Virtual items, which may be digital assets, objects, or enhancements that players can acquire, collect, trade, and/or otherwise use within the game. Examples of virtual items include weapons, armor, vehicles, pets and companions, special abilities/power-ups, cosmetic skins, and emotes.
Character enhancements, refers to improving a player character's abilities, attributes, or equipment to enhance their performance and capabilities within the game. For example, leveling up, acquiring new skills, upgrading equipment, or unlocking special abilities.
Experience points. Experience points (XP) are a common gameplay mechanic used in various video games to measure a player character's progress and advancement. Players earn XP through various in-game actions such as defeating enemies, completing quests, exploring the game world, or achieving specific objectives.
Exclusive access to game content. Exclusive access to game content may refer to special and/or limited-time content that is only available to certain players or under specific conditions. This content can include unique items, levels, characters, or features that are not accessible to the general player base.
Achievements. Achievements may be in-game rewards or acknowledgments granted to players for accomplishing specific tasks, reaching milestones, or completing challenges within the game. Achievements may be tracked and displayed in a player's profile or gaming platform account. Examples of achievements include for: completion (e.g., main story mission, side quest, other objectives), progression (e.g., reach a specific character level or milestone), combat (e.g., incurred damage or success), and multi-players (e.g., win against others).

The candidate gaming scenario may be virtually implemented by not presenting an indication of the candidate gaming scenario and/or an indication of the virtual implementation on client terminals of the users.

Alternatively or additionally, the virtually implemented candidate gaming scenario includes a virtual time challenge scenario. In the virtual time challenge scenario, users are tasked with completing specific virtual in-game objectives and/or achieving virtual milestones within virtual predefined time limits. The virtual time challenge is implemented without presenting on a client terminal of a user: the virtual in-game objectives, indication of whether the virtual milestones are met, and/or virtual predefined time limits.

Alternatively or additionally, the virtually implemented candidate gaming scenario includes a hidden objectives scenario. The hidden objectives scenario is not presented on client terminals of users such that users engage with the game engine without explicit knowledge of undisclosed in-game objectives.

In the case of two (or more) user sub-groups, the candidate gaming scenario may be implemented for the first user sub-set and not-implemented for the second user sub-set. The first user sub-set and the second user sub-set interact with the gaming engine, optionally simultaneously. For example, players of the first user sub-set and the second user sub-set may simultaneously play the game run by the gaming engine, where each sub-set is aware of the other sub-set and/or is able to interact with the other sub-set. Alternatively, the players of the first user sub-set may play together, and the players of the second user sub-set may play together a different instance of the game without being aware of the players of the first sub-set. Alternatively, each player of each sub-set may play alone, independently of the other players, without necessarily being aware of the other players. The first user sub-set and the second user sub-set may be selected to be statistically similar, for example, in terms of one or more parameters such as demographics, play level, play style, and the like. The scenario of selecting the first user sub-set and the second user sub-set may be for conducting a study, for example, a randomized blinded control trial, a retrospective study, and the like.

At 208, the service engine collects and/or analyzes data on the users, optionally the identified sub-set of users. The data may be collected while the (sub-set of) users interact with the gaming engine virtually implementing the candidate gaming scenario, without the users being aware of the virtual implementation.

The service engine may collect data on user interactions during the virtual time challenge scenario. The service engine may calculate virtual outcomes based on user performance against virtual time-related criteria. The calculated results may be presented on a display that is different than displays of client terminals of the users. An indication of the virtual time challenge scenario is not presented on the client terminals of the users.

The service engine may collect data on user interactions during the hidden objectives scenario without presenting an indication of the hidden objective scenario on client terminals used by users throughout the data collection phase. The calculation of the game related result may be done by determining virtual outcomes based on user actions related to the undisclosed in-game objectives. The calculated game related result(s) may be presented on a display that is different than displays of client terminals of the users. The indication of the hidden objectives scenario is not presented on the client terminals of the users.

Optionally, the service engine categorizes users (e.g., within the identified sub-set) into user groups based on one or more of:
User characteristics. For example, age ranges, gaming experience, and skill level.
Preferences. For example, aggressive playstyle focusing on engaging in combat and securing kills. In another example, a more passive or strategic approach, prioritizing objectives and teamwork. In yet another example, communication preferences for communication between teammates and opponents. Some players prefer using in-game chat or voice chat for coordination and strategy, while others may prefer minimal communication or prefer to communicate through pings and emotes.
Behaviors. For example, motivation factors such as competition, mastery, social interactions, and entertainment. Some players are driven by the desire to climb the ranked ladder and improve their skills, while others enjoy the social aspect of playing with friends or the thrill of intense matches.
Game-play. For example, some players may dedicate several hours each day to playing the game, while others may only play occasionally or during specific times. In another example, some players may prefer solo queue matches, while others enjoy playing in premade teams or participating in e-sports events.

The service engine may analyze the distribution of computed game related result(s) within each identified user group. The game related result(s) may be predicted for each user group. For example, a certain reward scenario may be predicted to be suitable for children, but unsuitable for adults such as likely to lead to in-game inflation. The service engine may identify patterns and/or trends across the different distinct user groups, for providing insights regarding the actual activation of the candidate gaming scenario.

At 210, one or more game related results may be computed by the service engine using the data collected for the virtually implemented candidate gaming scenario.

The game related result(s) may represent a prediction of when the candidate gaming scenario is explicitly implemented by the gaming engine.

The game related results may be direct computations based on the collected data. For example, the game related results may refer to 20% of the players that were able to collect 10 virtual tokens by completing an in-game objective within 15 minutes of the start of the game.

Alternatively or additionally, the game related results may be an analysis of the collected data. The data may be analyzed, for example, by feeding into a trained ML model (e.g., trained on a training dataset of collected data and ground truth of analysis outcomes), applying a decision model, a set of rules, and/or manually by a user. An example of an analysis is as follows: for the data of 20% percentage of the players that were able to collected 10 virtual tokens by completing an in-game objective within 15 minutes of the start of the game, the analysis may indicate that high in-game inflation is expected.

The game related result(s) predicted to occur may directly correspond to the game related result(s) computed for the virtually implemented candidate gamine scenario. Alternatively or additionally, the game related result(s) may be computed by adjusting the collected data according to a predicted adjustment factor. The predicted adjustment factor may indicate a predicted impact on users being presented with an indication of the implemented candidate gaming scenario in comparison to users being unaware of the implemented candidate gaming scenario. For example, users being aware of an implementation of a gaming scenario in which they earn more virtual money than user unware of the implementation may spend more of the money in comparison to the unaware users, which may lead to outcomes such an increased game inflation. The increase in spending may be predicted based on the predicted adjustment factor. It is noted that the unaware users receive the same virtual currency rewards as the aware users, but are not aware that they have this extra virtual money. The predicted adjustment factor may be computed by analyzing a first set of users interacting with a game engine in which a candidate gaming scenario is explicitly implemented and a second set of users interacting with a game engine in which the candidate gaming scenario is virtually implemented.

At 212, data may be presented on a display of a client terminal, for example, of a developer and/or operator of the gaming engine and/or operator of the service engine.

The presented data may include data collected during the virtual implementation of the candidate gaming scenario, and/or analysis of the data, and/or game related result(s). The presented data may include calculated potential reward outcomes.

The display on which the data is presented may not display the game being played, so that the user in unaware of the data. The data may be presented on a display of an operator that is not a player of the game, for example, an operator of the service engine.

Data may be presented within a user interface (UI), optionally a graphical user interface. The data may be presented in a comprehensible format within the UI. The UI may indicate, for example, the calculated potential rewards outcomes based on the adapted reward calculation that are virtually determined and non-presented to users and/or reward outcomes based on the existing reward calculation that are presented to users.

Optionally, the GUI presented on the display is designed for reviewing and/or analyzing the collected data and/or the game relate results. For example, the GUI is designed for reviewing and/or analyzing the calculated potential reward outcomes based on the adapted reward calculation and/or the reward outcomes based on the existing reward calculations.

The GUI may be designed for enabling the operator to activate the candidate reward scenario. For example, game related results are presented for one or more candidate reward scenarios which are virtually implemented. The operator may select which candidate rewards scenarios are to be explicitly implemented by the gaming engine.

At 214, the candidate gaming scenario (e.g., the selected candidate gaming scenario) may be explicitly implemented by the gaming engine for interaction by the users. Explicitly implementing the candidate gaming scenario may refer to presenting the indication of the implemented candidate gaming scenario on the client terminals of the users. In other words to make the users (e.g., all users) aware of the previously virtually implemented candidate gaming scenario.

The candidate gaming scenario may be automatically explicitly implemented by the gaming engine. Alternatively, when the operator uses the GUI to manually select which candidate gaming scenario to explicitly implement, the explicit implementation may be done automatically in response to the selection.

The candidate gaming scenario may be implemented in response to the game related result(s) meeting a target. The target may refer to one or more of:
A balance of the gaming engine. Candidate gaming scenarios that balance the gaming engine may be implemented. The balance of the gamine engine may refer to for example, reducing likelihood of domination by a single strategy, character, item, and/or an ability. The balance may be for fair and/or enjoyable play by the user.
A statistically significant positive outcome in a difference between the first user sub-set in which the candidate gaming scenario was virtually implemented and the second user sub-set in which the candidate gaming scenario was not virtually implemented. For example, that the first user sub-set experienced an improved play experience in comparison to the second user sub-set, as measured, for example, by increase play time, increased communication between users, increased buy and sell activity, and the like.
A statistically non-significant difference between the first user sub-set in which the candidate gaming scenario was virtually implemented and the second user sub-set in which the candidate gaming scenario was not virtually implemented. For example, no in-game inflation is predicted to occur for the first user sub-set in which a new reward allocation was virtually implemented, and for the second sub-set in which the old reward allocation was used, indicating that the new reward allocation may be explicitly implemented without risk of in-game inflation.
Predetermined expectations. A comparison between reward outcomes (i.e., the game related result(s)) computed according to the adapted reward calculation and the predetermined expectations may be performed, to determine whether the game related results meet or do not meet predicted expectations.
A performance benchmark, for example, computed according to the existing reward calculation. The game related result may be compared to the performance benchmark, to determine whether or not the game result meet or do not meet the performance benchmark.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant gaming engines will be developed and the scope of the term gaming engine is intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of predicting an effect of a candidate gaming scenario on users interacting with a gaming engine implementing the candidate gaming scenario, comprising:
accessing, in conjunction with a service engine configured to manage the gaming engine, the candidate gaming scenario to be implemented in the gaming engine and in conjunction with the users, wherein the candidate gaming scenario is associated with at least one desired outcome of users interacting with the gaming engine implementing the candidate gaming scenario;
identifying, in the gaming engine and in conjunction with the service engine, a sub-set of the users interacting with the gaming engine for analyzing the candidate gaming scenario implemented by the gaming engine;
virtually implementing the candidate gaming scenario by the gaming engine for interaction by the users as if the candidate gaming scenario is not virtually implemented;
collecting data, by the service engine, on the sub-set of users identified, in conjunction with the users interacting with the gaming engine virtually implementing the candidate gaming scenario;
computing at least one game related result predicted to occur when the new gaming scenario is explicitly implemented by the candidate gaming engine using the data collected for the virtually implemented candidate gaming engine scenario; and
in response to the at least one game related scenario meeting a target, explicitly implementing the candidate gaming scenario for interaction by the users.

2. The computer implemented method of claim 1, wherein the candidate gaming scenario comprises a candidate reward scenario defining a replacement of an existing reward calculation with an adapted reward calculation for virtual allocation of rewards, wherein the rewards are virtually allocated for each user without presenting an indication of the virtually allocated rewards.

3. The computer implemented method of claim 2, wherein the service engine calculates the rewards that each user would have earned based on their interactions and performance under the candidate reward scenario, by application of predefined rules and criteria of the virtual reward scenario to ascertain the virtual rewards each user would have received, providing a simulated representation of potential reward outcomes without actual explicit distribution of rewards to the users.

4. The computer implemented method of claim 2, wherein types of rewards within the candidate gaming scenario for virtual allocation comprise at least one of: (i) in-game currency, (ii) virtual items, (iii) character enhancements, (iv) experience points, (v) exclusive access to game content, and (vi) achievements.

5. The computer implemented method of claim 2, wherein the adapted reward calculation comprises applying predefined rules and criteria of the candidate reward scenario to determine the virtual rewards each user would have earned without explicitly allocating the rewards to each user.

6. The computer implemented method of claim 2, further comprising presenting the calculated potential reward outcomes on a display in a comprehensible format indicating the calculated potential rewards outcomes based on the adapted reward calculation that are virtually determined and non-presented to users and reward outcomes based on the existing reward calculation that are presented to users.

7. The computer implemented method of claim 6, further comprising presenting a user interface (GUI) on the display configured for reviewing and/or analyzing the calculated potential reward outcomes based on the adapted reward calculation and the reward outcomes based on the existing reward calculations, and configured for enabling the user to activate the candidate reward scenario.

8. The computer implemented method of claim 2, wherein the candidate reward scenario is automatically implemented in response to a comparison between the reward outcomes computed according to the adapted reward calculation and predetermined expectations and/or performance benchmarks computed according to the existing reward calculation.

9. The computer implemented method of claim 1, wherein the candidate gaming scenario comprises a virtual time challenge scenario, wherein users are tasked with completing specific virtual in-game objectives and/or achieving virtual milestones within virtual predefined time limits without being presented with the virtual in-game objectives, indication of whether the virtual milestones are met, and virtual predefined time limits, in which the service engine collects data on user interactions during the virtual time challenge scenario, calculates virtual outcomes based on user performance against virtual time-related criteria, and presents the calculated results on a display that is different than displays of client terminals of the users without presenting an indication of the virtual time challenge scenario on the client terminals of the users.

10. The computer implemented method of claim 1, wherein the candidate gaming scenario comprises a hidden objectives scenario that is non-presented on client terminals of users such that users engage with the game engine without explicit knowledge of undisclosed in-game objectives, in which the service engine collects data on user interactions during the hidden objectives scenario without presenting an indication of the hidden objective scenario on client terminals used by users throughout the data collection phase, and in which the calculation of the at least one game related result comprises determining virtual outcomes based on user actions related to the undisclosed in-game objectives, and the calculated at least one game related result is presented on a display that is different than displays of client terminals of the users without presenting an indication of the hidden objectives scenario on the client terminals of the users.

11. The computer implemented method of claim 1, further comprising categorizing users within the identified sub-set into user groups based on at least one of: (i) user characteristics, (ii) preferences, (iii) behaviors, and (iv) game-play, and wherein the at least one game related result is predicted for each user group.

12. The computer implemented method of claim 11, wherein the service engine is configured to analyze the distribution of computed at least one game related result within each identified user group.

13. The computer implemented method of claim 12, wherein the service engine is configured to identify patterns and/or trends across distinct user groups, for providing insights regarding the actual activation of the candidate gaming scenario.

14. The computer implemented method of claim 1, wherein virtually implementing the candidate gaming scenario comprises not presenting an indication of the candidate gaming scenario and/or an indication of the virtual implementation on client terminals of the users, and wherein explicitly implementing the candidate gaming scenario comprises presenting the indication of the implemented candidate gaming scenario on the client terminals of the users.

15. The computer implemented method of claim 1, wherein the identified sub-set of users comprises a first user sub-set, and the candidate gaming scenario is implemented for the first user sub-set and non-implemented for a second user sub-set different from the first sub-set, wherein the first user sub-set and the second user sub-set are simultaneously interacting with the gaming engine, wherein no indication of allocation of a user to the first user sub-set or to the second user sub-set is presented on a display of a client terminal of the user.

16. The computer implemented method of claim 15, wherein the first user sub-set and the second user sub-set are statistically similar, for enabling a randomized blinded control trial.

17. The computer implemented method of claim 15, wherein the candidate gaming scenario is automatically explicitly implemented by the gaming engine in response to the target indicating a statistically significant positive outcome in a difference between the first user sub-set and the second user sub-set.

18. The computer implemented method of claim 15, wherein the candidate gaming scenario is automatically explicitly implemented by the gaming engine in response to the target indicating a statistically non-significant difference between the first user sub-set and the second user sub-set.

19. The computer implemented method of claim 1, wherein the identified sub-set of users is selected according to a prediction of being significantly impacted by the candidate gaming scenario.

20. The computer implemented method of claim 1, wherein the target denotes a balance of the gaming engine obtained by implementing the candidate gaming scenario for reducing likelihood of domination by a single strategy, character, item, an ability, for fair and enjoyable play by the user.

21. The computer implemented method of claim 1, wherein the identified sub-set of users represents a statistical sample of users that historically interacted with the gaming engine, and/or are currently interacting with the gaming engine, and/or are predicted to interact with the gaming engine in the future.

22. The computer implemented method of claim 1, wherein the sub-set of users is identified by analyzing at least one parameter of each user denoting a selected segment of users, the at least one parameter including at least one of: skill level, play style, and demographics.

23. The computer implemented method of claim 1, wherein the at least one game related result is computed by adjusting the collected data according to a predicted adjustment factor indicating predicted impact on users being presented with an indication of the implemented candidate gaming scenario in comparison to users being unaware of the implemented candidate gaming scenario.

24. The computer implemented method of claim 23, wherein the predicted adjustment factor is computed by analyzing a first set of users interacting with a game engine in which a candidate gaming scenario is explicitly implemented and a second set of users interacting with a game engine in which the candidate gaming scenario is virtually implemented.

25. A system for predicting an effect of a candidate gaming scenario on users interacting with a gaming engine implementing the candidate gaming scenario, comprising:
at least one processor executing a code for:
accessing, in conjunction with a service engine configured to manage the gaming engine, the candidate gaming scenario to be implemented in the gaming engine and in conjunction with the users, wherein the candidate gaming scenario is associated with at least one desired outcome of users interacting with the gaming engine implementing the candidate gaming scenario;
identifying, in the gaming engine and in conjunction with the service engine, a sub-set of the users interacting with the gaming engine for analyzing the candidate gaming scenario implemented by the gaming engine;
virtually implementing the candidate gaming scenario by the gaming engine for interaction by the users as if the candidate gaming scenario is not virtually implemented;
collecting data, by the service engine, on the sub-set of users identified, in conjunction with the users interacting with the gaming engine virtually implementing the candidate gaming scenario;
computing at least one game related result predicted to occur when the new gaming scenario is explicitly implemented by the candidate gaming engine using the data collected for the virtually implemented candidate gaming engine scenario; and
in response to the at least one game related scenario meeting a target, explicitly implementing the candidate gaming scenario for interaction by the users.

26. A non-transitory medium storing program instructions for predicting an effect of a candidate gaming scenario on users interacting with a gaming engine implementing the candidate gaming scenario, which when executed by at least one processor, cause the at least one processor to:
access, in conjunction with a service engine configured to manage the gaming engine, the candidate gaming scenario to be implemented in the gaming engine and in conjunction with the users, wherein the candidate gaming scenario is associated with at least one desired outcome of users interacting with the gaming engine implementing the candidate gaming scenario;
identify, in the gaming engine and in conjunction with the service engine, a sub-set of the users interacting with the gaming engine for analyzing the candidate gaming scenario implemented by the gaming engine;
virtually implement the candidate gaming scenario by the gaming engine for interaction by the users as if the candidate gaming scenario is not virtually implemented;
collect data, by the service engine, on the sub-set of users identified, in conjunction with the users interacting with the gaming engine virtually implementing the candidate gaming scenario;
compute at least one game related result predicted to occur when the new gaming scenario is explicitly implemented by the candidate gaming engine using the data collected for the virtually implemented candidate gaming engine scenario; and
in response to the at least one game related scenario meeting a target, explicitly implement the candidate gaming scenario for interaction by the users.
